(19) United States
(12) Patent Application Publication
(10) Pub. No.: US 2013/0088351 A1
(43) Pub. Date: Apr. 11, 2013

(54) SYSTEM AND METHOD FOR NOTIFYING OF AND MONITORING DANGEROUS SITUATIONS USING MULTI-SENSOR

(71) Applicants: Geon Woo KIM, Daejeon (KR); Young Gyu JUNG, Incheon (KR)

(72) Inventors: Geon Woo KIM, Daejeon (KR); Young Gyu JUNG, Incheon (KR)

(73) Assignee: Electronics and Telecommunications Research Institute, Daejeon (KR)

(21) Appl. No.: 13/620,111

(22) Filed: Sep. 14, 2012

(30) Foreign Application Priority Data
Oct. 7, 2011 (KR) 10-2011-0102426

(51) Int. Cl. G08B 1/08

(52) U.S. Cl. 340/539.22

(57) ABSTRACT

Provided is technology for sensing and monitoring dangerous situations, and more specifically, a system and method for notifying of and monitoring dangerous situations in real time. There is provided a system for notifying of and monitoring a dangerous situation using a multi-sensor, including: a dangerous situation notification apparatus configured to sense occurrence of a dangerous situation, and to create dangerous situation notification information; a dangerous situation collection apparatus configured to receive the dangerous situation notification information, to detect a location at which the dangerous situation has occurred based on the dangerous situation notification information, and to collect information about the dangerous situation from the location at which the dangerous situation has occurred; and a dangerous situation control apparatus configured to receive information about the location at which the dangerous situation has occurred, and the information about the dangerous situation, thereby monitoring the dangerous situation.

### CLAIM FOR PRIORITY

This application claims priority to Korean Patent Application No. 10-2011-0102426 filed on Oct. 7, 2011 in the Korean Intellectual Property Office (KIPO), the entire contents of which are hereby incorporated by reference.

### BACKGROUND

1. Technical Field

Example embodiments of the present invention relate in general to technology for sensing and monitoring dangerous situations, and more specifically to a system and method for notifying of and monitoring dangerous situations in real time.

2. Related Art

People that are in dangerous situations need to get help from others as soon as possible. For this, it is important to immediately notify of a dangerous situation and the exact location at which the dangerous situation has occurred.

A conventional method for notifying of a dangerous situation and coping with it is to analyze images collected through CCTV and detect and pursue an object that is in a dangerous situation. However, the conventional method encountered difficulties in immediately notifying of dangerous situations and detecting and coping with dangers in real time due to dead zones and various environmental factors of dangerous regions.

Further, a conventional method of detecting the location of an object that is in a dangerous situation using only RFID or GPS information could not be applied to specific environments such as an indoor space, or encountered difficulties in detecting the exact location of the object.

One of the related conventional technologies is disclosed in Korean Patent Registration No. 10-0982398, entitled “State Monitoring System Using Zigbee and CCTV.” The conventional system includes a Zigbee AP configured to identify information of a Zigbee tag included on an electronic name card and to transmit the identified information to a Zigbee gateway; a CCTV placed in a high-crime region, and configured to capture images of what takes place in the region and to transmit the images to an administrative server; the Zigbee gateway configured to collect location information of electronic name cards through communication with the Zigbee AP to database the location information; and the administrative server configured to monitor the location information of the electronic name cards and images received from CCTVs placed in high-crime regions, and to control the information.

However, there are still difficulties in immediately notifying of dangerous situations and detecting exact locations at which the dangerous situations have taken place only using Zigbee and CCTV. Also, when objects (for example, children) are monitored regardless of occurrences of dangerous situations, it is also difficult to take immediate action when a dangerous situation has occurred.

### SUMMARY

Accordingly, example embodiments of the present invention are provided to substantially obviate one or more problems due to limitations and disadvantages of the related art.

The present invention provides a system for sensing a dangerous situation in real time to notify of the dangerous situation, and detecting a location at which the dangerous situation has occurred to collect information about the dangerous situation to thereby help take immediate action against the dangerous situation.

The present invention also provides a method for sensing a dangerous situation in real time to notify of the dangerous situation, and detecting a location at which the dangerous situation has occurred to collect information about the dangerous situation to thereby help take immediate action against the dangerous situation.

In some example embodiments, there is provided a system for notifying of and monitoring a dangerous situation using a multi-sensor, including: a dangerous situation notification apparatus configured to sense occurrence of a dangerous situation, and to create dangerous situation notification information; a dangerous situation collection apparatus configured to receive the dangerous situation notification information, to detect a location at which the dangerous situation has occurred based on the dangerous situation notification information, and to collect information about the dangerous situation from the location at which the dangerous situation has occurred; a dangerous situation control apparatus configured to receive information about the location at which the dangerous situation has occurred, and the information about the dangerous situation, thereby monitoring the dangerous situation.

The dangerous situation notification apparatus may include at least one of a sound generator, a GPS receiver, an RFID chip, and a voice recognizer.

The dangerous situation collection apparatus may include at least one of a sound tracker, a GPS tracker, a CCTV, an RFID reader, and a voice recognizer.

In other example embodiments, there is provided a method for notifying of and monitoring a dangerous situation using a multi-sensor, including: at a dangerous situation notification apparatus, sensing occurrence of a dangerous situation, and transmitting dangerous situation notification information for notifying that the dangerous situation has occurred; at a dangerous situation collection apparatus, receiving the dangerous situation notification information, detecting a location at which the dangerous situation has occurred based on the dangerous situation notification information, collecting information about the dangerous situation from the location at which the dangerous situation has occurred, and transmitting information about the location at which the dangerous situation has occurred, and the information about the dangerous situation; and at a dangerous situation control apparatus, receiving information about the location at which the dangerous situation has occurred, and the information about the dangerous situation, thereby monitoring the dangerous situation in order to take action against the dangerous situation.

### BRIEF DESCRIPTION OF DRAWINGS

Example embodiments of the present invention will become more apparent by describing in detail example embodiments of the present invention with reference to the accompanying drawings, in which:

FIG. 1 is a diagram illustrating a configuration example of a system for notifying of and monitoring dangerous situations using a multi-sensor.

FIG. 2 is a flowchart illustrating an example of a method for notifying of and monitoring dangerous situations using a multi-sensor.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items. It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, embodiments of the present invention will be described in detail with reference to the appended drawings.

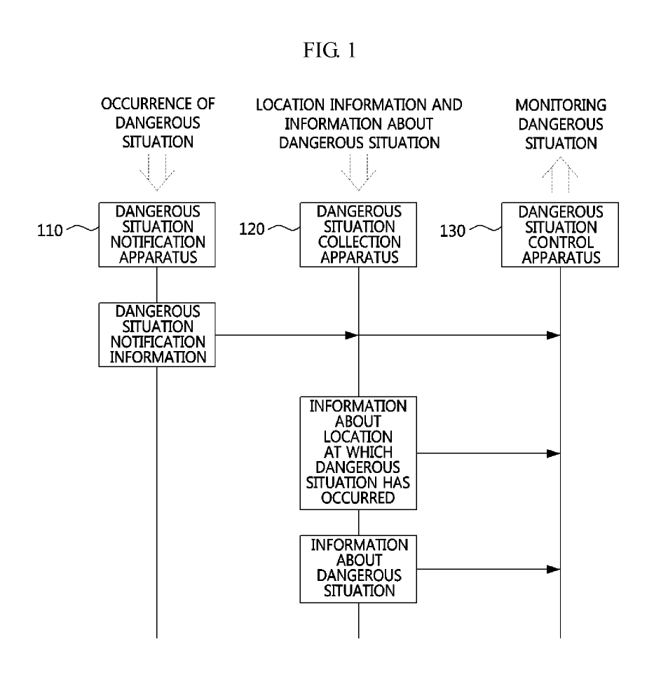

FIG. 1 is a diagram illustrating a configuration example of a system for notifying of and monitoring dangerous situations using a multi-sensor.

Referring to FIG. 1, the system includes a dangerous situation notification apparatus 110, a dangerous situation collection apparatus 120, and a dangerous situation control apparatus 130.

The dangerous situation notification apparatus 110 may be carried by an object (hereinafter referred to as a “user”) who may be in a dangerous situation, or placed in a specific region. When a certain situation that is dangerous to the user occurs or a dangerous situation occurs in the user's surroundings, the dangerous situation notification apparatus 110 may sense the dangerous situation, create dangerous situation notification information for notifying of the dangerous situation, and transmit the dangerous situation notification information to the dangerous situation collection apparatus 120 or the dangerous situation control apparatus 130. That is, the dangerous situation notification apparatus 110 may be configured to include various kinds of sensors capable of sensing and notifying of dangerous situations. Also, the dangerous situation notification apparatus 110 may further include a communication module for transmitting dangerous situation notification information. Here, the situation that is dangerous to the user or the dangerous situation that may occur in the user's surroundings includes all situations that can occur due to dangerous factors, such as a traffic accident, violence, access to a restricted access region, an arson attack, etc.

The dangerous situation notification apparatus 110 may be configured to include various kinds of sensors capable of sensing or notifying of dangerous situations. Accordingly, the dangerous situation notification apparatus 110 may include at least one of a sound generator, a GPS receiver, an RFID chip, and a voice recognizer. For example, the sound generator may generate sound to notify of occurrence of a dangerous situation, the GPS receiver or the RFID chip may sense or notify of access to a restricted access region, etc., and the voice recognizer may recognize a voice generated from a user's surroundings to detect occurrence of a dangerous situation.

When a dangerous situation has occurred, the dangerous situation collection apparatus 120 receives dangerous situation notification information created by and transmitted from the dangerous situation notification apparatus 110 to thereby determine that the dangerous situation has occurred. Then, the dangerous situation collection apparatus 120 detects information about a location at which the dangerous situation has occurred, and collects information about the dangerous situation based on the location. The information about the dangerous situation includes the kind of danger, a degree of danger, a time at which the dangerous situation occurred, image information related to the dangerous situation, information about the user, etc. That is, the dangerous situation collection apparatus 120 collects information about dangerous situations based on location. Also, the dangerous situation collection apparatus 120 may transmit the information about the location at which the dangerous situation has occurred and the information about the dangerous situation to the dangerous situation control apparatus 130. Accordingly, the dangerous situation collection apparatus 120 may include various kinds of sensors capable of collecting information about dangerous situations, and a communication module for exchanging information with the dangerous situation notification apparatus 110 and the dangerous situation control apparatus 130.

Accordingly, the dangerous situation collection apparatus 120 may include at least one of a sound tracker, a GPS tracker, a CCTV, an RFID reader, and a voice recognizer. The dangerous situation collection apparatus 120 may receive dangerous situation notification information created by the dangerous situation notification apparatus 110, and detect information about a location at which the dangerous situation has occurred. Also, the dangerous situation collection apparatus 120 may collect information about dangerous situations. For example, the sound tracker may track sound to estimate a location at which the sound was generated, and the GPS tracker may track a GPS receiver to estimate a location at which a dangerous situation has occurred. Also, the CCTV may be placed in a high-crime region to capture images of what takes place in the region and collect image information about dangerous situations that have occurred. The RFID reader may recognize RFID chips and detect the locations of users carrying the RFID chips.

The dangerous situation control apparatus 130 receives the dangerous situation notification information created by and transmitted from the dangerous situation notification apparatus 110 to display information for notifying that the dangerous situation has occurred. Also, the dangerous situation control apparatus 130 may receive the information about the location at which the dangerous situation has occurred and the information about the dangerous situation from the dangerous situation collection apparatus 120, and display the information about the location and the information about the dangerous situation. Accordingly, the dangerous situation control apparatus 130 may be configured to include a display. That is, the dangerous situation control apparatus 130 displays locations at which dangerous situations have occurred and information about the dangerous situations, thereby monitoring dangerous situations.

The dangerous situation control apparatus 130 may be one of various kinds of devices capable of monitoring dangerous situations. Accordingly, the dangerous situation control apparatus 130 includes at least one of a smart phone, a PDA, a computer, a TV, and a navigation system. That is, the dangerous situation control apparatus 130 may receive dangerous situation notification information, information about the location at which the dangerous situation has occurred, and information about the dangerous situation from the dangerous situation notification apparatus 110 or the dangerous situation collection apparatus 120, and display the information about the location and the information about the dangerous situation, thereby monitoring the dangerous situation.

Accordingly, the present invention provides a system for notifying of and monitoring a dangerous situation using a multi-sensor, including: a dangerous situation notification apparatus configured to sense occurrence of a dangerous situation, and to create dangerous situation notification information; a dangerous situation collection apparatus configured to receive the dangerous situation notification information, to detect a location at which the dangerous situation has occurred based on the dangerous situation notification information, and to collect information about the dangerous situation from the location at which the dangerous situation has occurred; a dangerous situation control apparatus configured to receive information about the location at which the dangerous situation has occurred and the information about the dangerous situation, thereby monitoring the dangerous situation.

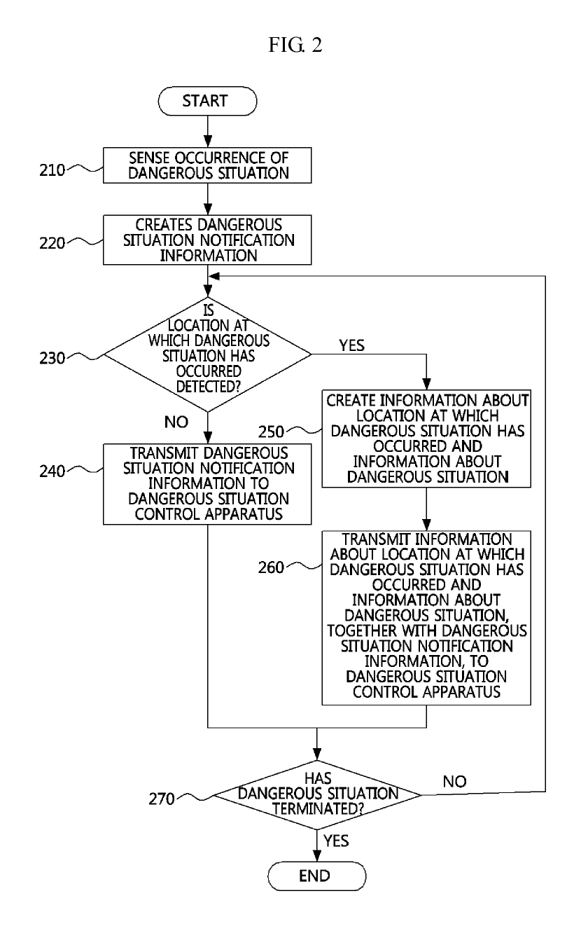

FIG. 2 is a flowchart illustrating an example of a method for notifying of and monitoring dangerous situations using a multi-sensor.

Referring to FIGS. 1 and 2, a method for notifying of and monitoring dangerous situations using a multi-sensor will be described below.

When a dangerous situation has occurred, the dangerous situation is sensed by the dangerous situation notification apparatus 110 that is carried by a user or placed in a location at which the dangerous situation has occurred (210). Then, the dangerous situation notification apparatus 110 creates dangerous situation notification information (220). If the dangerous situation collection apparatus 120 receives the dangerous situation notification information, the dangerous situation collection apparatus 120 detects the location at which the dangerous situation has occurred (230). If the dangerous situation collection apparatus 120 detects no location at which the dangerous situation has occurred, only the dangerous situation notification information is transmitted to the dangerous situation control apparatus 130 (240). Meanwhile, if the dangerous situation collection apparatus 120 detects the location at which the dangerous situation has occurred, the dangerous situation collection apparatus 120 collects and creates information about the location at which the dangerous situation has occurred and information about the dangerous situation (250). The information about the location at which the dangerous situation has occurred and the information about the dangerous situation, together with the dangerous situation notification information, are transmitted to the dangerous situation control apparatus 130 (260). Particularly, the information about the dangerous situation includes image data about the dangerous situation collected by a CCTV included in the dangerous situation collection apparatus 120. Also, if it is determined that the dangerous situation persists based on the information about the dangerous situation collected by the dangerous situation collection apparatus 120, an operation of detecting the location at which the dangerous situation has occurred continues to be performed to continue to collect information about the dangerous situation. Meanwhile, if it is determined that the dangerous situation has terminated, the operation of collecting information about the dangerous situation also terminates (270).

That is, according to the example of FIG. 2, the present invention provides a method for notifying of and monitoring a dangerous situation using a multi-sensor, including: at a dangerous situation notification apparatus, sensing occurrence of a dangerous situation, and transmitting dangerous situation notification information for notifying that the dangerous situation has occurred; at a dangerous situation collection apparatus, receiving the dangerous situation notification information, detecting a location at which the dangerous situation has occurred based on the dangerous situation notification information, collecting information about the dangerous situation from the location at which the dangerous situation has occurred, and transmitting information about the location at which the dangerous situation has occurred and the information about the dangerous situation; and at a dangerous situation control apparatus, receiving information about the location at which the dangerous situation has occurred, and the information about the dangerous situation, thereby monitoring the dangerous situation in order to take action against the dangerous situation.

Also, the monitoring of the dangerous situation includes receiving the dangerous situation notification information and displaying information for notifying that the dangerous situation has occurred.

Therefore, as described above, by sensing occurrence of a dangerous situation using various kinds of sensors, notifying that a dangerous situation has occurred in real time, and detecting an exact location at which the dangerous situation has occurred, it is possible to collect information about the dangerous situation in real time. Also, by displaying the location at which a dangerous situation has occurred and collected information about the dangerous situation, it is possible to track the dangerous situation and take immediate action against the dangerous situation.

While the example embodiments of the present invention and their advantages have been described in detail, it should be understood that various changes, substitutions and alterations may be made herein without departing from the scope of the invention.

What is claimed is:

1. A system for notifying of and monitoring a dangerous situation using a multi-sensor, comprising:
a dangerous situation notification apparatus configured to sense occurrence of a dangerous situation, and to create dangerous situation notification information;
a dangerous situation collection apparatus configured to receive the dangerous situation notification information, to detect a location at which the dangerous situation has occurred based on the dangerous situation notification information, and to collect information about the dangerous situation from the location at which the dangerous situation has occurred;
a dangerous situation control apparatus configured to receive information about the location at which the dangerous situation has occurred, and the information about the dangerous situation, thereby monitoring the dangerous situation.

2. The system of claim 1, wherein the dangerous situation notification apparatus includes at least one of a sound generator, a GPS receiver, an RFID chip, and a voice recognizer.

3. The system of claim 1, wherein the dangerous situation collection apparatus includes at least one of a sound tracker, a GPS tracker, a CCTV, an RFID reader, and a voice recognizer.

4. A method for notifying of and monitoring a dangerous situation using a multi-sensor, comprising:
sensing, at a dangerous situation notification apparatus, occurrence of a dangerous situation, and transmitting dangerous situation notification information for notifying that the dangerous situation has occurred;
receiving, at a dangerous situation collection apparatus, the dangerous situation notification information, detecting a location at which the dangerous situation has occurred based on the dangerous situation notification information, collecting information about the dangerous situation from the location at which the dangerous situation has occurred, and transmitting information about the location at which the dangerous situation has occurred and the information about the dangerous situation; and
receiving, at a dangerous situation control apparatus, information about the location at which the dangerous situation has occurred, and the information about the dangerous situation, thereby monitoring the dangerous situation in order to take action against the dangerous situation.

5. The method of claim 4, wherein the monitoring of the dangerous situation comprises receiving the dangerous situation notification information and displaying information for notifying that the dangerous situation has occurred.

6. The method of claim 4, wherein the dangerous situation notification apparatus includes at least one of a sound generator, a GPS receiver, an RFID chip, and a voice recognizer.

7. The method of claim 4, wherein the dangerous situation collection apparatus includes at least one of a sound tracker, a GPS tracker, a CCTV, an RFID reader, and a voice recognizer.

8. The method of claim 4, wherein the dangerous situation control apparatus includes at least one of a smart phone, a PDA, a computer, a TV, and a navigation system.
